(19) United States
(12) Patent Application Publication
(10) Pub. No.: US 2020/0262391 A1
(43) Pub. Date: Aug. 20, 2020

(54) METHODS, SYSTEMS, AND MEDIA FOR TRANSMITTING ACTION INFORMATION USING QR CODES

(71) Applicant: Thien Van Pham, Lacey, WA (US)

(72) Inventor: Thien Van Pham, Lacey, WA (US)

(21) Appl. No.: 16/280,571

(22) Filed: Feb. 20, 2019

(51) Int. Cl. B60R 25/24; G06K 19/06; H04L 9/30

(52) U.S. Cl. CPC B60R 25/241; B60R 2325/108; H04L 9/30; G06K 19/06037

(57) ABSTRACT

Methods, systems, and media for performing actions using Quick Response (QR) codes are provided. In some embodiments, the method comprises: generating, at a secondary user device, a unique identifier (UID) and a Public Key Infrastructure (PKI) key pair, wherein the PKI key pair includes a public key and a private key; generating a QR code using the UID, wherein the QR code includes an indication of an action to be performed by the secondary device; causing the QR code to be presented on a display associated with the secondary user device; receiving, from a primary device, encrypted action data that corresponds to the indication of the action to be performed by the secondary device; decrypting the encrypted action data using the private key of the PKI key pair; and causing the action to be performed by the secondary device using the decrypted action data.

### TECHNICAL FIELD

The disclosed subject matter relates to methods, systems, and media for transmitting action information using QR codes.

### BACKGROUND

Quick Response (QR) codes have become a common way to share information with people. For example, a QR code can include information such as a Uniform Resource Locator (URL), product information, etc., which can be scanned by a user device, such as a mobile phone, thereby providing a user of the user device with information embedded in the QR code. However, the information included in a QR code may not be secured in any manner. In some cases, this can allow a hacker to capture and manipulate a QR code, thereby causing an unsuspecting user to scan a QR code that leads the user to a malicious site or a QR code that activates an application that steals user information (e.g., user credentials, etc.). It can be difficult to generate a QR code that secures information included in the QR code or that securely causes an action to be performed.

Accordingly, it is desirable to provide new methods, systems, and media for transmitting action information using QR codes.

### SUMMARY

Methods, systems, and media for transmitting action information using QR codes are provided.

In accordance with some embodiments of the disclosed subject matter, a method for performing actions using Quick Response (QR) codes is provided, the method comprising: generating, at a secondary user device, a unique identifier (UID) and a Public Key Infrastructure (PKI) key pair, wherein the PKI key pair includes a public key and a private key; generating a QR code using the UID, wherein the QR code includes an indication of an action to be performed by the secondary device; causing the QR code to be presented on a display associated with the secondary user device; receiving, from a primary device, encrypted action data that corresponds to the indication of the action to be performed by the secondary device; decrypting the encrypted action data using the private key of the PKI key pair; and causing the action to be performed by the secondary device using the decrypted action data.

In accordance with some embodiments of the disclosed subject matter, a system for performing actions using Quick Response (QR) codes is provided, the system comprising: a memory; and a hardware processor that, when executing computer executable instructions stored in the memory, is configured to: generate, at a secondary user device, a unique identifier (UID) and a Public Key Infrastructure (PKI) key pair, wherein the PKI key pair includes a public key and a private key; generate a QR code using the UID, wherein the QR code includes an indication of an action to be performed by the secondary device; cause the QR code to be presented on a display associated with the secondary user device; receive, from a primary device, encrypted action data that corresponds to the indication of the action to be performed by the secondary device; decrypt the encrypted action data using the private key of the PKI key pair; and cause the action to be performed by the secondary device using the decrypted action data.

In accordance with some embodiments of the disclosed subject matter, a method for causing actions to be performed using Quick Response (QR) codes is provided, the method comprising: authenticating a user of a primary device to an application executing on the primary device; capturing an image of a QR code presented on a secondary device using the application; extracting information included in the QR code to determine action data requested by the secondary device to perform an action associated with the QR code; retrieving a Public Key Infrastructure (PKI) public key corresponding to the secondary device; generating the action data; encrypting the action data using the PKI public key; and transmitting the encrypted action data to the secondary device, wherein the secondary device is configured to perform the action associated with the QR code in response to receiving the encrypted action data.

In accordance with some embodiments of the disclosed subject matter, a system for causing actions to be performed using Quick Response (QR) codes is provided, the system comprising: a memory; and a hardware processor that, when executing computer executable instructions stored in the memory, is configured to: authenticate a user of a primary device to an application executing on the primary device; capture an image of a QR code presented on a secondary device using the application; extract information included in the QR code to determine action data requested by the secondary device to perform an action associated with the QR code; retrieve a Public Key Infrastructure (PKI) public key corresponding to the secondary device; generate the action data; encrypting the action data using the PKI public key; and transmit the encrypted action data to the secondary device, wherein the secondary device is configured to perform the action associated with the QR code in response to receiving the encrypted action data.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a process for generating a QR code that includes action information in accordance with some embodiments of the disclosed subject matter.

FIG. 2 shows an example of a process for capturing a QR code that includes action information in accordance with some embodiments of the disclosed subject matter.

FIG. 3 shows an example of a user interface for logging in to an application using a QR code in accordance with some embodiments of the disclosed subject matter.

FIG. 4 shows an example of an illustration of a vehicle on which actions can be performed using a QR code in accordance with some embodiments of the disclosed subject matter.

FIG. 5 shows an example of an illustration of a vehicle navigation display on which actions can be performed using a QR code in accordance with some embodiments of the disclosed subject matter.

FIG. 6 shows a schematic diagram of an illustrative system suitable for implementation of mechanisms described herein for transmitting action information using QR codes in accordance with some embodiments of the disclosed subject matter.

FIG. 7 shows a detailed example of hardware that can be used in a server and/or a user device of FIG. 6 in accordance with some embodiments of the disclosed subject matter.

### DETAILED DESCRIPTION

In accordance with various embodiments, mechanisms (which can include methods, systems, and media) for transmitting action information using QR codes are provided.

In some embodiments, the mechanisms described herein can be used to generate a QR code that can be used to perform an action. In some embodiments, the mechanisms can be implemented on a primary device and a secondary device. For example, in some embodiments, a secondary device (e.g., a smart television, a vehicle computer, an Internet of Things (IoT) device, and/or any other suitable device) can generate a QR code as well as a public and private key and can present the QR code on a display associated with the secondary device. In some embodiments, the QR code generated by the secondary device can request particular action data from a primary device that is required to complete a particular action, such as user credentials for logging into an account, user credentials for activating a particular feature of the secondary device, and/or any other suitable action data. In some embodiments, the primary device (e.g., a mobile phone, and/or any other suitable user device) can then scan the QR code presented on a display associated with the secondary device. In some embodiments, a primary device can use a public key generated by the secondary device to encrypt action data requested by the secondary device in the QR code and can transmit the encrypted action data to the secondary device. In some embodiments, the secondary device can decrypt encrypted action data using a private key generated by the secondary device and can then use the decrypted action data to perform any suitable action.

In some embodiments, an action associated with a QR code can be any action that can be performed by a secondary device. For example, in some embodiments, an action can include logging in to a user account using encrypted user credentials transmitted by a primary device to a secondary device. As another example, in some embodiments, an action can include use of a third-party site or service, such as booking a hotel, buying a product, ordering a service, and/or any other suitable action. As yet another example, in some embodiments, an action can include unlocking a door, opening a trunk of a vehicle, starting an engine of a vehicle, and/or performing any other suitable action.

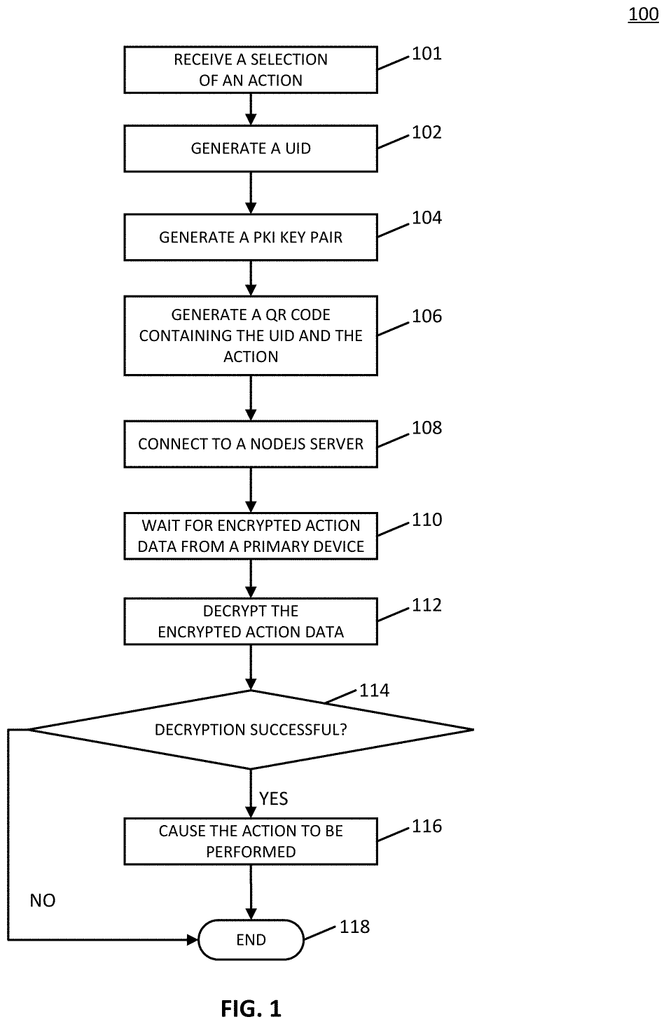

Turning to FIG. 1, an example 100 of a process for generating a QR code that includes action information is shown in accordance with some embodiments of the disclosed subject matter. In some embodiments, blocks of process 100 can be executed on a secondary user device that is to perform any suitable action, such as unlocking a door, logging in to a user account, rolling down car windows, and/or performing any other suitable action.

Process 100 can begin at 101 by receiving a selection of an action. In some embodiments, the action can be any suitable action, such as unlocking a door, logging in to a user account, rolling down car windows, and/or any other suitable action. In some embodiments, process 100 can receive the selection of the action in any suitable manner. For example, in some embodiments, process 100 can receive the selection of the action via a user interface presented on an application executing on the secondary device. As a more particular example, in some embodiments, the user interface presented on the application can present options of candidate actions that can be performed via the secondary device. As a specific example, in an instance where the secondary device is a vehicle computer, the user interface can present options of candidate actions that can be performed on a vehicle associated with the vehicle computer, such as starting an engine, unlocking a door, etc. In some embodiments, process 100 can present the user interface that presents options of candidate actions in response to determining that a user of the secondary device has logged in to a user account associated with the user and corresponding to the application.

Process 100 can begin at 102 by generating a unique identifier (UID). In some embodiments, the UID can correspond to the secondary device, a particular action to be performed by the secondary device, a combination of the secondary device and an action to be performed by the secondary device, and/or any other suitable system. In some embodiments, the UID can be in any suitable format, such as a string of letters, a string of numbers, and/or a string of any other suitable characters.

At 104, process 100 can generate a PKI key pair. In some embodiments, the PKI key pair can include a public key and a private key. In some embodiments, process 100 can use any suitable technique(s) and/or protocols to generate the PKI key pair.

At 106, process 100 can generate a QR code containing the UID and information related to an action to be completed. In some embodiments, the information related to the action can include a request for information that is required by the secondary device from a primary device that scans the QR code to perform the action. For example, in some embodiments, the information related to the action can indicate particular user credentials required to complete the action (e.g., a username associated with a particular account, that a password associated with a particular user account is required, and/or any other suitable user credential information).

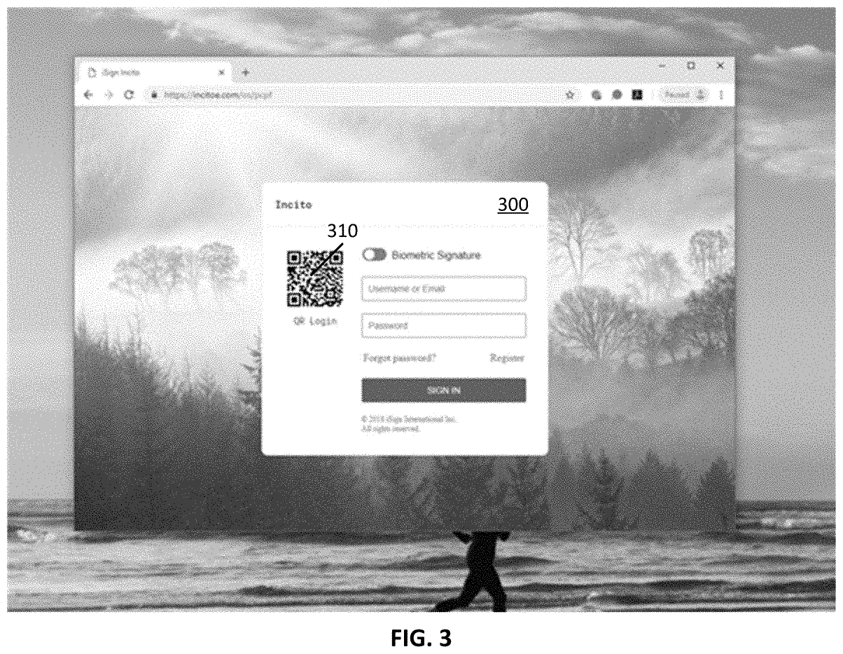

In some embodiments, the action can be any suitable action to be performed by the secondary device. For example, in instances where the secondary device is a user device (e.g., a tablet computer, a desktop computer, a smart television, an IoT device, and/or any other suitable type of user device), the action can correspond to logging in to a user account. Turning to FIG. 3, an example 300 of a user interface that can be presented on a secondary device for logging in to a user account on the secondary device is shown in accordance with some embodiments of the disclosed subject matter. As illustrated, user interface 300 can include user interface controls for entering a username and/or a password associated with the user account. Additionally, in some embodiments, user interface 300 can include QR code 310. In some such embodiments, a primary user device (e.g., a mobile phone, and/or any other suitable first user device) can capture an image of QR code 310 and can transmit any suitable user credential information for logging in to the user account to the secondary device as encrypted action data, as described below in more detail in connection with 110-116.

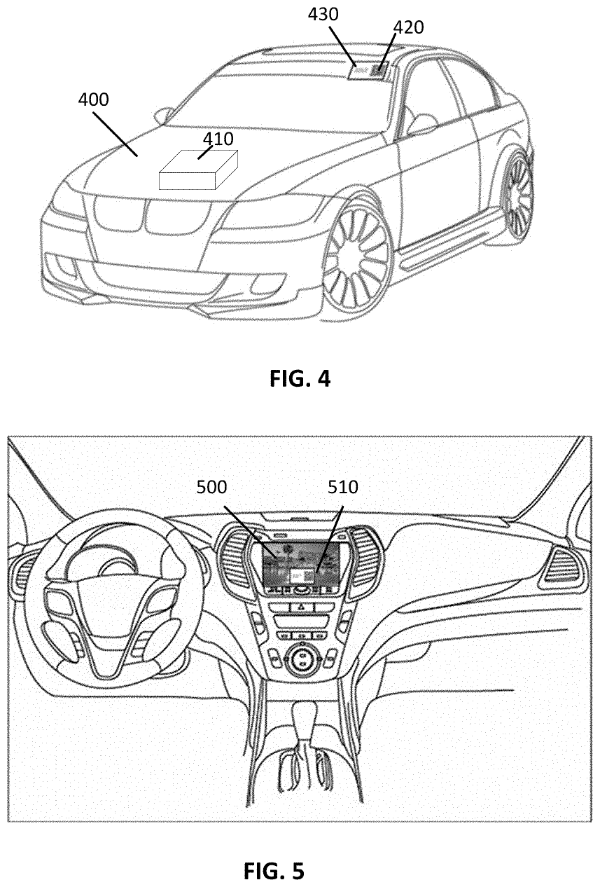

As another example, in instances where the secondary device is a computer associated with a vehicle, the action can correspond to any suitable action to be performed on the vehicle, such as unlocking doors or windows, rolling down a window, starting an engine, opening or unlocking a trunk, and/or performing any other suitable action. Turning to FIG. 4, an example of an illustration of a vehicle 400 on which actions can be performed is shown in accordance with some embodiments of the disclosed subject matter. As illustrated, vehicle 400 can be associated with a vehicle computer 410. In some such embodiments, a display 430 associated with vehicle computer 410 can present a QR code 420. In some embodiments, vehicle computer 410 can cause any suitable action indicated in QR code 420 to be performed in response to receiving data from a primary user device that captures an image of QR code 420, as described below in connection with 110-116.

As yet another example, in some embodiments, the action can include an action to be performed via a website or other service, such as booking a hotel, booking movie tickets, and/or any other suitable action. Turning to FIG. 5, an example of an illustration of a vehicle navigation display on which actions can be performed using a QR code is shown in accordance with some embodiments of the disclosed subject matter. As illustrated, a QR code 510 can be presented on a display 500 (e.g., a navigation display of a vehicle, and/or any other suitable display). In some such embodiments, in response to receiving encrypted action data from a primary user device (e.g., encrypted user credential information, encrypted payment information, and/or any other suitable encrypted action data) that captures an image of QR code 510, a secondary device associated with display 500 can cause the action associated with QR code 510 to be performed, such as booking or purchasing a service or product using the action data from the primary device.

Referring back to FIG. 1, in some embodiments, process 100 can generate the QR code using any suitable technique or combination of techniques. For example, in some embodiments, data represented by the QR code can be formatted in any suitable manner such that a program associated with the first user device that captures the image of the QR code can use the data to determine the UID and/or the action contained in the QR code. As a more particular example, in some embodiments, the UID and/or the information related to the action (e.g., action data that is requested from the primary device to complete the action, and/or any other suitable information related to the action) can each be represented as a string that is included in the QR code in any suitable manner. As another more particular example, in some embodiments, the information related to the action can be embedded within the UID.

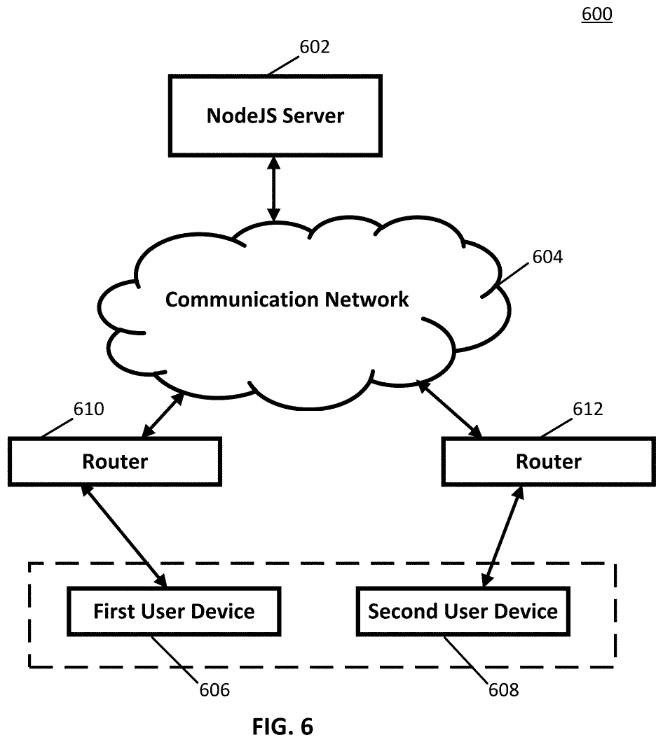

At 108, process 100 can connect to a NodeJS server, such as NodeJS server 602 as shown in and described below in connection with FIG. 6. In some embodiments, the NodeJS server can allow the secondary device to communicate with an application executing on a primary device (e.g., an application executing on a primary device that is used to capture a QR code displayed by the secondary device, and/or any other suitable application). In some embodiments, process 100 can connect to the NodeJS server in any suitable manner. For example, in some embodiments, process 100 can create a new socket of the NodeJS server. As a more particular example, in some embodiments, the secondary device can use the UID as a string that represents the socket of the NodeJS server. In some embodiments, by connecting to the NodeJS server, the secondary device can establish a single channel using the UID and the action. In some such embodiments, no other user device can join the channel using the UID.

At 110, process 100 can wait for encrypted action data required to complete the action from a primary device.

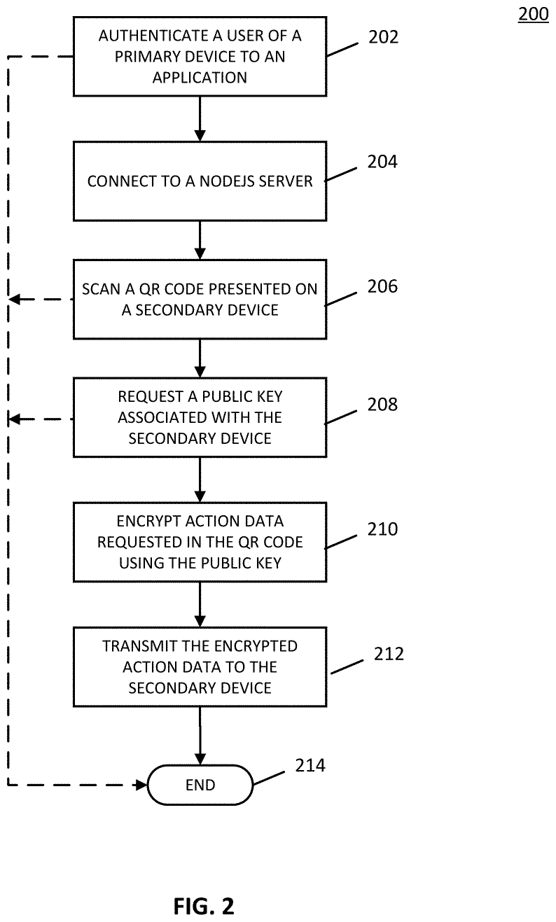

Turning to FIG. 2, an example 200 of a process for capturing an image of a QR code for performing an action is shown in accordance with some embodiments of the disclosed subject matter. In some embodiments, blocks of process 200 can be performed on a primary device that captures a QR code generated by and presented by a secondary device (as described above in connection with FIG. 1).

Process 200 can begin at 202 by authenticating a user of a primary device to an application. In some embodiments, the application can be any suitable application, such as an application that executes on the primary device that is used to capture an image of a QR code, transmit action data required by a secondary device that generated the QR code to the secondary device to complete an action, and/or perform any other suitable functions. In some embodiments, the application can communicate with the secondary device via a NodeJS server, as described above in connection with 108 of FIG. 1 and below in connection with FIG. 6.

In some embodiments, the user can be authenticated to the application in any suitable manner. For example, in some embodiments, the user can enter user credentials (e.g., a username and/or a password) via a user interface associated with the application that is presented on the primary device. As another example, in some embodiments, the user can be authenticated using any suitable biometric data. Note that, in some embodiments, in instances where process 200 determines that the user of the primary device was not successfully authenticated to the application (e.g., because the user entered an incorrect username and/or password, and/or for any other reason), process 200 can end at 214.

At 204, process 200 can connect to a NodeJS server. In some embodiments, the NodeJS server can be any suitable NodeJS server, such as the NodeJS server the secondary device connected to at 108, as described above in connection with FIG. 1. In some embodiments, process 200 can connect to the NodeJS server in any suitable manner. For example, in some embodiments, process 200 can use an identifier of the user of the primary device to connect to the NodeJS server, such as a username associated with the user, an email address associated with the user, a UID, and/or any other suitable unique identifier of the user.

At 206, process 200 can scan a QR code presented on the secondary device. In some embodiments, process 200 can scan the QR code in any suitable manner. For example, in some embodiments, process 200 can use a camera associated with the primary device to capture an image of the QR code presented on a display associated with the secondary device.

Note that, in some embodiments, process 200 can determine if the QR code was successfully scanned based on any suitable criteria. For example, in some embodiments, process 200 can determine whether an image of the QR code was fully captured. As another example, in some embodiments, process 200 can determine whether a quality of an image of the QR code is of sufficient quality (e.g., not blurry, and/or based on any other suitable quality metrics). In some embodiments, in response to determining that the QR code was not successfully scanned, process 200 can end at 214.

At 208, process 200 can request a public key associated with the secondary device (e.g., the public key generated at 104, as described above in connection with FIG. 1). In some embodiments, process 200 can request the public key in any suitable manner. For example, in some embodiments, process 200 can transmit a request from the primary device to the secondary device requesting the public key via the NodeJS server. In some embodiments, process 200 can then receive the requested public key from the secondary device in response to the request. Note that, in some embodiments, if the request for the public key was not successful (e.g., the secondary device did not respond to the request, and/or the request was unsuccessful in any other suitable manner), process 200 can end at 214.

At 210, process 200 can encrypt action data requested in the QR code using the public key. In some embodiments, process 200 can extract information related to the action from the captured QR code using any suitable technique or combination of techniques. For example, in some embodiments, process 200 can use any suitable technique to extract a string that indicates requested action information (e.g., a requested username, a requested password, requested payment information, and/or any other requested information required to complete the action) from the QR code. In some such embodiments, process 200 can then generate action data based on the extracted information. For example, in some embodiments, the generated action data can include a string that includes requested user credentials. Process 200 can then encrypt the action data using the public key and any suitable PKI encryption protocol(s).

At 212, process 200 can transmit the encrypted action data to the secondary device. In some embodiments, process 200 can transmit the encrypted action data to the secondary device in any suitable manner. For example, in some embodiments, process 200 can transmit the encrypted action data via the NodeJS server that process 200 previously connected to at 204. As a more particular example, in some embodiments, process 200 can transmit the encrypted action data from the primary device to the secondary device via the channel established using the NodeJS server. In some such embodiments, process 200 can use the UID associated with the QR code to transmit the encrypted action data via the NodeJS server.

Process 200 can then end at 214.

Referring back to FIG. 1, at 112, once received, process 100 can decrypt the encrypted action data. In some embodiments, process 100 can decrypt the encrypted action data using the private key generated at 104 and any suitable PKI decryption protocol(s).

Note that, in some embodiments, the secondary device can receive encrypted action data that has been received from the primary device in any suitable manner. For example, in some embodiments, the NodeJS server can use an event listener and/or any other suitable technique to determine that the primary device has transmitted encrypted action data to be transmitted to the secondary device, and the NodeJS server can then transmit the encrypted action data to the secondary device.

At 114, process 100 can determine whether the decryption was successful. In some embodiments, process 100 can determine whether the decryption was successful using any suitable technique or combination of techniques. For example, in some embodiments, process 100 can determine whether a PKI decryption protocol used to decrypt the encrypted action data returned any errors. As another example, in some embodiments, process 100 can determine whether the decrypted action data is valid. As a more particular example, in some embodiments, process 100 can determine whether the decrypted action data is valid for the action to be performed. As a specific example, in an instance where the action to be performed is logging in to a website, and where the action data requested by the secondary device is user credentials for the website, process 100 can determine whether the decrypted action data includes valid user credentials (e.g., a username and/or a password in a correct format, and/or any other suitable valid user credentials).

If, at 114, process 100 determines that the decryption was not successful (“no” at 114), process 100 can end at 118.

If, at 114, process 100 determined that the decryption was successful (“yes” at 114), process 100 can, at 116, cause the action associated with the QR code to be performed. In some embodiments, process 100 can cause the action to be performed using the decrypted action data. For example, in some embodiments, process 100 can cause the action to be performed by using user credentials included in the decrypted action data.

As described above in connection with 106, the action can be any suitable action that can be performed by the secondary device. For example, in some embodiments, the action can include logging in to a user account using user credentials passed to the secondary device from the primary device. As another example, in some embodiments, the action can include any suitable action(s) to be performed using a third-party site or service, such as booking a hotel room, purchasing tickets to an event, and/or any other suitable action(s). In some such embodiments, process 100 can use payment information included in the encrypted action data to purchase a product or service. As yet another example, in instances where the secondary device corresponds to a vehicle computer, the action(s) can include performing any suitable action(s) on the vehicle, such as unlocking doors or windows, opening a trunk, starting an engine, and/or performing any other suitable action(s). As still another example, in instances where the secondary device corresponds to an IoT device (e.g., a smart appliance, a smart lock, and/or any other suitable IoT device), the action can include any suitable action that can be performed by the IoT device.

Process 100 can then end at 118.

Turning to FIG. 6, an example 600 of hardware for transmitting action information using QR codes that can be used in accordance with some embodiments of the disclosed subject matter is shown. As illustrated, hardware 600 can include a NodeJS server 602, a communication network 604, one or more user devices 606, such as first user device 606 and second user device 608, and/or one or more routers, such as router 610 and/or 612.

NodeJS server 602 can be any suitable server(s) for storing information, data, programs, and/or any other suitable content. For example, in some embodiments, NodeJS server 602 can receive connections from second user device 608 and can establish a channel for secure communication between second user device 608 and first user device 606, as shown in and described above in connection with FIGS. 1 and 2. Note that, although server 602 is generally described herein as operating a NodeJS backend, in some embodiments, server 602 can use any suitable packages or infrastructure to establish channels with user devices.

Note that, although server 602 is generally described herein as a server that executes a NodeJS backend, in some embodiments, server 602 can use any suitable technique(s) or packages to allow multiple user devices to communicate through channels established via server 602.

Communication network 604 can be any suitable combination of one or more wired and/or wireless networks in some embodiments. For example, communication network 604 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 606 and 608 can be connected by one or more communications links to communication network 604 that can be linked via one or more communications links to NodeJS server 602. In some embodiments, user devices 606 and 608 can be connected to communication network 604 via one or more routers, such as router 610 and/or router 612. For example, in some embodiments, first user device 606 can be connected to communication network 604 via router 610, and second user device 608 can be connected to communication network 604 via router 612. In some embodiments, the communications links can be any communications links suitable for communicating data among user devices 606 and 608 and NodeJS server 602 such as network links, dial-up links, wireless links, hard-wired links, any other suitable communications links, or any suitable combination of such links.

In some embodiments, first user device 606 can be any suitable user device that can capture an image of a QR code presented by second user device 608. For example, in some embodiments, first user device 606 can be a mobile device, such as a mobile phone, a tablet computer, a wearable computer, and/or any other suitable type of mobile device. In some embodiments, second user device 608 can be any suitable type of user device for generating a QR code, presenting the QR code, and/or performing any suitable action in response to receiving data from first user device 606 that captures an image of the QR code. For example, in some embodiments, second user device 608 can be a laptop computer, a tablet computer, a desktop computer, a smart television, a vehicle computer, an Internet of Things (IoT) device (e.g., a smart appliance, a thermostat, a smart lock, and/or any other suitable type of IoT device), and/or any other suitable type of device.

Although server 602 is illustrated as one device, the functions performed by server 602 can be performed using any suitable number of devices in some embodiments. For example, in some embodiments, multiple devices can be used to implement the functions performed by server 602.

Although two user devices 606 and 608 are shown in FIG. 6 to avoid over-complicating the figure, any suitable number of user devices, and/or any suitable types of user devices, can be used in some embodiments.

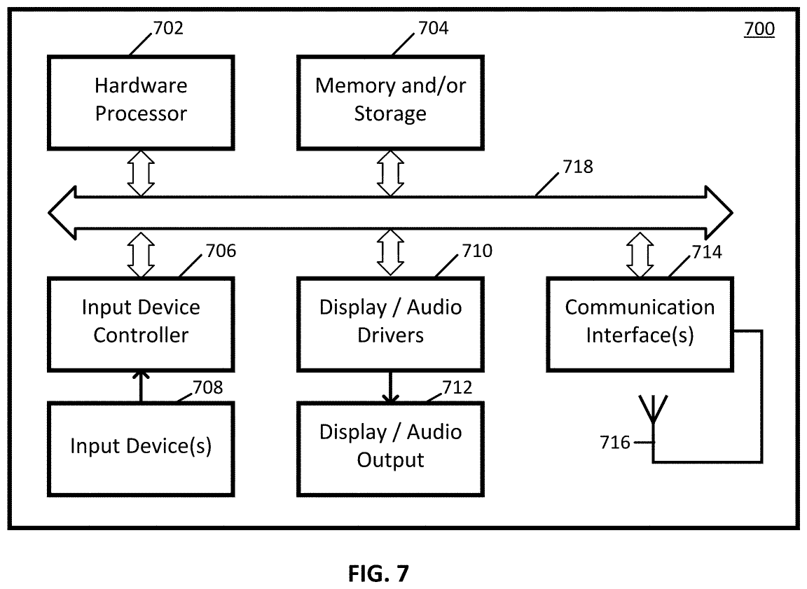

Server 602 and user devices 606 and 608 can be implemented using any suitable hardware in some embodiments. For example, in some embodiments, devices 602, 606, and/or 608 can be implemented using any suitable general-purpose computer or special-purpose computer. For example, a mobile phone may be implemented using a special-purpose computer. Any such general-purpose computer or special-purpose computer can include any suitable hardware. For example, as illustrated in example hardware 700 of FIG. 7, such hardware can include hardware processor 702, memory and/or storage 704, an input device controller 706, an input device 708, display/audio drivers 710, display and audio output circuitry 712, communication interface(s) 714, an antenna 716, and a bus 718.

Hardware processor 702 can include any suitable hardware processor, such as a microprocessor, a micro-controller, digital signal processor(s), dedicated logic, and/or any other suitable circuitry for controlling the functioning of a general-purpose computer or a special-purpose computer in some embodiments. In some embodiments, hardware processor 702 can be controlled by a server program stored in memory and/or storage of a server, such as server 602. In some embodiments, hardware processor 702 can be controlled by a computer program stored in memory and/or storage of a user device, such as first user device 606 and/or second user device 608.

Memory and/or storage 704 can be any suitable memory and/or storage for storing programs, data, and/or any other suitable information in some embodiments. For example, memory and/or storage 704 can include random access memory, read-only memory, flash memory, hard disk storage, optical media, and/or any other suitable memory.

Input device controller 706 can be any suitable circuitry for controlling and receiving input from one or more input devices 708 in some embodiments. For example, input device controller 706 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 710 can be any suitable circuitry for controlling and driving output to one or more display/audio output devices 712 in some embodiments. For example, display/audio drivers 710 can be circuitry for driving a touchscreen, a flat-panel display, a cathode ray tube display, a projector, a speaker or speakers, and/or any other suitable display and/or presentation devices.

Communication interface(s) 714 can be any suitable circuitry for interfacing with one or more communication networks (e.g., computer network 604). For example, interface(s) 714 can include network interface card circuitry, wireless communication circuitry, and/or any other suitable type of communication network circuitry.

Antenna 716 can be any suitable one or more antennas for wirelessly communicating with a communication network (e.g., communication network 604) in some embodiments. In some embodiments, antenna 716 can be omitted.

Bus 718 can be any suitable mechanism for communicating between two or more components 702, 704, 706, 710, and 714 in some embodiments.

Any other suitable components can be included in hardware 700 in accordance with some embodiments.

In some embodiments, at least some of the above described blocks of the processes of FIGS. 1 and 2 can be executed or performed in any order or sequence not limited to the order and sequence shown in and described in connection with the figures. Also, some of the above blocks of FIGS. 1 and 2 can be executed or performed substantially simultaneously where appropriate or in parallel to reduce latency and processing times. Additionally or alternatively, some of the above described blocks of the processes of FIGS. 1 and 2 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, methods, systems, and media for transmitting action information using QR codes are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

1. A method for performing actions using Quick Response (QR) codes, comprising:
generating, at a secondary user device, a unique identifier (UID) and a Public Key Infrastructure (PKI) key pair, wherein the PKI key pair includes a public key and a private key;
generating a QR code using the UID, wherein the QR code includes an indication of an action to be performed by the secondary device;
causing the QR code to be presented on a display associated with the secondary user device;
receiving, from a primary device, encrypted action data that corresponds to the indication of the action to be performed by the secondary device;
decrypting the encrypted action data using the private key of the PKI key pair; and causing the action to be performed by the secondary device using the decrypted action data.

2. The method of claim 1, wherein the encrypted action data includes user credentials to be used to perform the action.

3. The method of claim 1, wherein the action to be performed includes logging in to a user account.

4. The method of claim 1, wherein the action to be performed includes unlocking a door.

5. The method of claim 1, wherein the action to be performed is to be performed on a vehicle, and wherein the secondary device is a vehicle computer associated with the vehicle.

6. The method of claim 1, further comprising:
connecting to a NodeJS server; and
waiting for the encrypted action data, wherein the encrypted action data is received at the secondary device from the primary device via the NodeJS server.

7. A system for performing actions using Quick Response (QR) codes, the system comprising:
a memory; and
a hardware processor that, when executing computer executable instructions stored in the memory, is configured to:
generate, at a secondary user device, a unique identifier (UID) and a Public Key Infrastructure (PKI) key pair, wherein the PKI key pair includes a public key and a private key;
generate a QR code using the UID, wherein the QR code includes an indication of an action to be performed by the secondary device;
cause the QR code to be presented on a display associated with the secondary user device;
receive, from a primary device, encrypted action data that corresponds to the indication of the action to be performed by the secondary device;
decrypt the encrypted action data using the private key of the PKI key pair; and
cause the action to be performed by the secondary device using the decrypted action data.

8. The system of claim 7, wherein the encrypted action data includes user credentials to be used to perform the action.

9. The system of claim 7, wherein the action to be performed includes logging in to a user account.

10. The system of claim 7, wherein the action to be performed includes unlocking a door.

11. The system of claim 7, wherein the action to be performed is to be performed on a vehicle, and wherein the secondary device is a vehicle computer associated with the vehicle.

12. The system of claim 7, wherein the hardware processor is further configured to:
connect to a NodeJS server; and
wait for the encrypted action data, wherein the encrypted action data is received at the secondary device from the primary device via the NodeJS server.

13.-22. (canceled)

23. A non-transitory computer-readable medium containing computer executable instructions that, when executed by a processor, cause the processor to perform a method for performing actions using Quick Response (QR) codes, the method comprising:
generating, at a secondary user device, a unique identifier (UID) and a Public Key Infrastructure (PKI) key pair, wherein the PKI key pair includes a public key and a private key;
generating a QR code using the UID, wherein the QR code includes an indication of an action to be performed by the secondary device;
causing the QR code to be presented on a display associated with the secondary user device;
receiving, from a primary device, encrypted action data that corresponds to the indication of the action to be performed by the secondary device;
decrypting the encrypted action data using the private key of the PKI key pair; and causing the action to be performed by the secondary device using the decrypted action data.

24. The non-transitory computer-readable medium of claim 1, wherein the encrypted action data includes user credentials to be used to perform the action.

25. The non-transitory computer-readable medium of claim 1, wherein the action to be performed includes logging in to a user account.

26. The non-transitory computer-readable medium of claim 1, wherein the action to be performed includes unlocking a door.

27. The non-transitory computer-readable medium of claim 1, wherein the action to be performed is to be performed on a vehicle, and wherein the secondary device is a vehicle computer associated with the vehicle.

28. The non-transitory computer-readable medium of claim 1, wherein the method further comprises:
connecting to a NodeJS server; and
waiting for the encrypted action data, wherein the encrypted action data is received at the secondary device from the primary device via the NodeJS server.
